(19) United States
(12) Patent Application Publication
(10) Pub. No.: US 2015/0153933 A1
(43) Pub. Date: Jun. 4, 2015

(54) Navigating Discrete Photos and Panoramas

(71) Applicants: Daniel J. Filip, San Jose, CA (US); Dennis Tell, Stockholm (SE); Daniel Cotting, Islisberg (CH); Stephane Lafon, Sunnyvale, CA (US); Andrew T. Szybalski, San Francisco, CA (US); Luc Vincent, Palo Alto, CA (US)

(72) Inventors: Daniel J. Filip, San Jose, CA (US); Dennis Tell, Stockholm (SE); Daniel Cotting, Islisberg (CH); Stephane Lafon, Sunnyvale, CA (US); Andrew T. Szybalski, San Francisco, CA (US); Luc Vincent, Palo Alto, CA (US)

(73) Assignee: GOOGLE INC., MOUNTAIN VIEW, CA (US)

(21) Appl. No.: 13/422,277

(22) Filed: Mar. 16, 2012

(51) Int. Cl. G06F 17/30; G06F 3/0484; G06F 3/0481

(52) U.S. Cl. CPC G06F 3/04842; G06F 3/04817; G06F 17/3053

(57) ABSTRACT

Methods and systems for presenting imagery associated with a geographic location to a user include providing at least one geographic map or panoramic imagery to a client for display in an interface configured for interactive navigation of the at least one geographic map or panoramic imagery, receiving a user selection collected by the interface indicating a location corresponding to the at least one geographic map or panoramic imagery, identifying a plurality of images associated with the received user selection, obtaining at least one user preference associated with the identified images, ranking the identified images based on at least one of the retrieved user preferences, and providing at least one ranked image for display in the interface, in accordance with the ranking.

### BACKGROUND

1. Field

Embodiments generally relate to displaying geolocated images.

2. Background

Numerous web-based mapping services are available on the internet. Generally, these systems perform a variety of tasks, including displaying maps and satellite imagery, providing navigable street-level panoramas, determining navigation routes, and presenting navigation instructions to users.

Smartphones equipped with one or more high-quality digital cameras, GPS, abundant storage space, and mobile broadband are now commonly in use. These powerful devices allow individuals to easily capture and distribute images. Such capabilities have led to a surge in publicly-shared photography on the internet.

Further, many available photographs have been geotagged, enabling association with maps and other types of geolocated imagery. However, the enormous collection of existing content and growing number of shared photographs make it increasingly difficult for map service users to find images of particular interest.

### BRIEF SUMMARY

Methods and systems for presenting a discrete set of imagery associated with a geographic location are provided. These methods and systems give map service users greater control over imagery displayed for a geographic location.

In an embodiment, a method for presenting imagery associated with a geographic location includes providing at least one geographic map or panoramic imagery to a client for display in an interface configured for interactive navigation of the at least one geographic map or panoramic imagery. A user selection collected from the interface, which indicates a location corresponding to the at least one geographic map or panoramic imagery is received and multiple images associated with the user selection are identified. At least one user preference associated with the identified images is obtained, the identified images are ranked based on the at least one user preference, and at least one ranked image is provided for display in the interface, in accordance with the ranking.

In another embodiment, a system for presenting imagery associated with a geographic location to a user includes a user interface generator configured to provide at least one geographic map or panoramic imagery to a client for display in an interface configured for interactive navigation of the at least one geographic map or panoramic imagery, a user selection processor configured to receive a user selection collected by the interface, which indicates a location corresponding to the at least one geographic map or panoramic imagery, an image identifier configured to identify a plurality of imagery associated with the received user selection, a user preference manager configured to store and retrieve at least one user preference associated with the identified imagery, an image rank determiner configured to rank the identified imagery based on the at least one user preference, and an image provider configured to provide at least one ranked image for display in the interface in accordance with the ranking.

In yet another embodiment, a computer-readable storage medium having control logic recorded thereon is executed by a processor, causing the processor to present imagery associated with a geographic location to a user. The control logic includes a first computer-readable program code configured to cause the processor to provide at least one geographic map or panoramic imagery to a client for display in an interface configured for interactive navigation of the at least one geographic map or panoramic imagery. The control logic also includes a second computer-readable program code configured to cause the processor to receive a user selection collected by the interface, which indicates a location corresponding to the at least one geographic map or panoramic imagery. The control logic further includes a third computer-readable program code configured to cause the processor to identify a plurality of imagery associated with the received user selection, obtain at least one user preference associated with the identified imagery, and provide at least one ranked image for display in the interface in accordance with the ranking.

### BRIEF DESCRIPTION OF THE FIGURES

Embodiments are described with reference to the accompanying drawings. In the drawings, like reference numbers may indicate identical or functionally similar elements. The drawing in which an element first appears is generally indicated by the left-most digit in the corresponding reference number.

FIG. 1A is a block diagram of a system for providing imagery associated with a geographic location to a user, according to an embodiment.

FIG. 1B is a block diagram illustrating client and server components of a system for providing imagery associated with a geographic location to a user, according to an embodiment.

FIG. 2 is a flow diagram of a method for presenting imagery associated with a geographic location to a user, according to an embodiment.

FIG. 3 is a flow diagram of a method for presenting imagery associated with a geographic location to a user, according to another embodiment.

FIG. 4 is a block diagram illustrating a user interface for displaying a discrete set of photos and panoramas for a geographic location to a user, according to an embodiment.

FIG. 5 is a diagram of a computer system that may be used in embodiments.

### DETAILED DESCRIPTION

Embodiments are described herein with reference to the illustrative embodiments for particular applications, and it should be understood that the invention is not limited to the described embodiments. Those skilled in the art with access to the teachings provided herein will recognize additional modifications, applications, and embodiments within the scope thereof and additional fields in which the invention would be of significant utility.

In the detailed description of embodiments that follows, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Map service providers have integrated millions of shared photographs that are directly accessible from online maps and street-level panoramas. Available imagery may be indicated using a marker, thumbnail photo, or some other visual cue supplied with geolocated imagery. These indicators also allow the preview and display of photographs through user interaction such as clicking. In addition, a collection of related imagery may be displayed when a location or photograph has been selected by the user.

However, hundreds or even thousands of photographs may exist for a location or geographic space, and the amount of shared imagery continues to grow. It also is becoming increasingly common for multiple types of imagery, such as photographs and street-level panoramas, to exist for a single location.

These conditions present a significant challenge for any user looking to find the best available photography for a location, to easily identify images matching one or more personal preferences, or to remove unwanted imagery from display. For example, one user may be only interested in imagery with multiple navigation options to nearby photography. Another user may prefer colorful, detail-oriented images taken by a talented photographer. A different user may want to find the best available photography without any additional effort. Others may wish to locate popular images based on a number of display views and image ratings.

In conventional map services, users must accept imagery that is returned by default, sift through a large number of images, and take a multitude of additional steps to navigate to desired image types. Instead, users need improved ways to easily find and display images of interest based on individual preference.

The methods and systems disclosed herein are directed towards providing a user with greater control over imagery displayed for a geographic location. A user may specify one or more preferences related to image properties. Image properties may include one or more of attributes related to the an image file, qualities of an image itself, conditions existing or objects present within an image, and a relationship between an image and other imagery.

According to an embodiment user preferences relating to one or more image types, image qualities, and image properties may be detected automatically and also may be stored as user preferences. Automatically detected user preferences may be used alone or combined with one or more preferences that have been specified by the user.

Automatically detected user preferences may be based on common properties or qualities of imagery that a user has interacted with when using one or more applications or systems. Information used to automatically determine user preferences may be obtained from a local system and also may be requested from one or more remote systems either directly or using an API. Information received from one or more local and remote systems may then be aggregated and analyzed to automatically determine user preferences relating to imagery.

In another embodiment, user preferences may be automatically detected based on common properties associated with images that a user has selected, displayed, uploaded, downloaded, and saved in one or more collections over a period of time. User preferences also may be determined based on feedback, ratings, and comments that a user or other users similar to the user have provided for images. Such information regarding a user's interaction with and evaluation of imagery may be available and obtained from one or more applications and systems, including but not limited to photo sharing and social networking websites.

In other embodiments, user preferences may be used when determining whether to indicate the existence of available of imagery for a geographic location in association with a geolocated image. User preferences also may be used to rank and filter collections of imagery retuned for a selected location on a map, panorama or other geolocated image. In addition, user preferences may include settings for the display of imagery. For example, a user may indicate a preference for viewing street-level panoramas by default when multiple types of imagery are available for a geographic location. Other types of imagery may include, but are not limited to, various types photographs and video content.

Ranked images may be presented to a user in many different formats. For example, ranked images may be displayed in a sequenced order where the highest ranked result is displayed first and the lowest ranked result is displayed last. Ranked images also may be displayed in groupings or categories to help enable users to identify images having one or more attributes or images that may be of particular interest.

In an embodiment, images may be grouped into categories suggesting how closely the photos contained within each group match user interests. Such categories may be defined as highly correlated, moderately correlated, and remotely correlated in relation to one or more user preferences.

According to an embodiment, highly correlated images may match most or all user preferences, moderately correlated images may match some user preferences, and remotely correlated images may match only one or two indicated user preferences. Another embodiment may include images grouped by one or more defined user preferences relating to one or more of properties of an image file, image quality, contents or conditions present within an image, and at least one relationship between an image and other imagery.

A user also may specify default settings related to the display of imagery. For example, a user may indicate a preference for displaying a certain type of imagery, such as photographs, by default. A user may also choose to display a specific type of imagery, such as street-level panoramas, instead of one or more other types of imagery available for a location. A user may also indicate or define one or more preferred display layouts. In addition, user preferences may be further utilized as a filtering mechanism to trim the size of result sets, to ignore imagery having undesirable or unimportant characteristics, and to provide a more focused, manageable and personalized set of results for a user to enjoy.

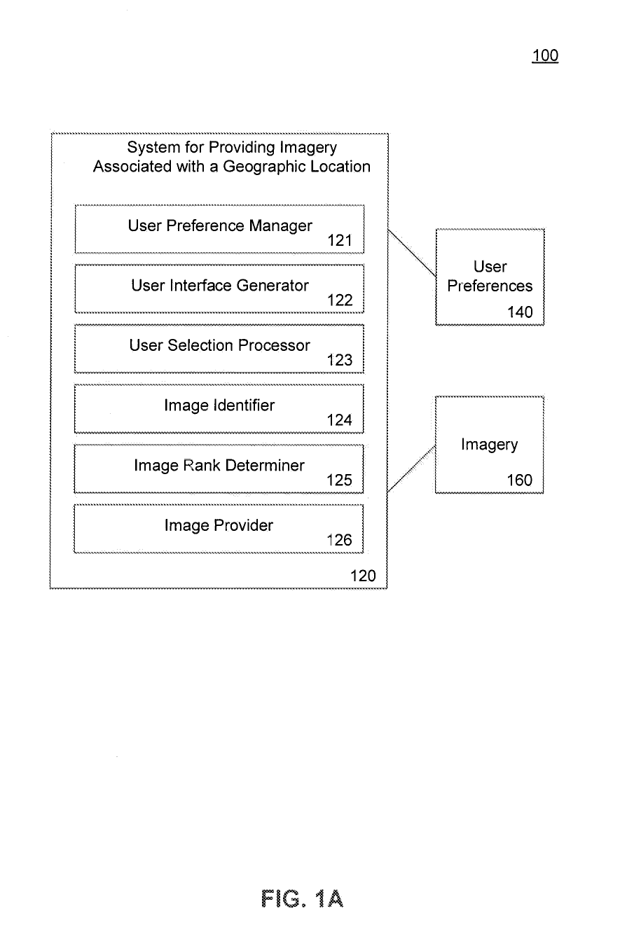

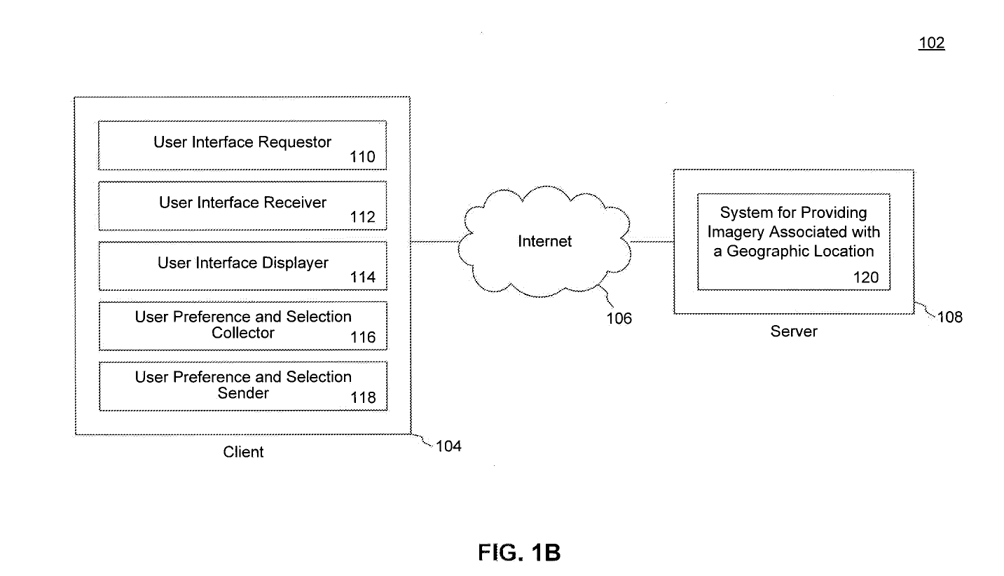

FIG. 1A is a block diagram of system 100 for presenting a discrete set of imagery associated with a geographic location to a user, according to an embodiment. System 100, or any combination of its components, may be part of, or may be implemented with, a computing device.

Examples of computing devices include, but are not limited to, a computer, workstation, distributed computing system, computer cluster, cloud computer system, embedded system, stand-alone electronic device, networked device, mobile device (e.g. mobile phone, smart phone, navigation device, tablet or mobile computing device), rack server, set-top box, or other type of computer system having at least one processor and memory. Such a computing device may include software, firmware, hardware, or a combination thereof. Software may include one or more applications and an operating system. Hardware may include, but is not limited to, a processor, memory, input and output devices, storage devices, and user interface display.

The computing device can be configured to access content hosted on servers over a network. The network can be any network or combination of networks that can carry data communications. Such a network can include, but is not limited to, a wired (e.g., Ethernet) or a wireless (e.g., Wi-Fi and 4G) network. In addition, the network can include, but is not limited to, a local area network, and/or wide area network such as the Internet. The network can support protocols and technology including, but not limited to, Internet or World Wide Web protocols and/or services. Intermediate network routers, gateways, or servers may be provided between servers and clients depending upon a particular application or environment.

System 100 includes a system for providing imagery associated with a geographic location 120, which includes various subsystems or components including a user preference manager 121, a user interface generator 122, a user selection processor 123, an image identifier 124, image rank determiner 125, and an image presenter 126.

Imagery, as discussed herein, generally refers to any projection of real space through a lens onto a camera sensor. Imagery includes, but is not limited to, any type of two dimensional photograph, three-dimensional photograph, or video content. Geolocated imagery is any imagery associated with geographical coordinates or a location and may indicate properties such as latitude and longitude, altitude, and image orientation.

User preference manager 121 may be configured to create, determine, manage, store, and access user preferences 140 for any individual user. User preference manager may also be configured to automatically detect user preferences 140 based on past activities of a user and other available information, which may be located on a system for providing imagery associated with a geographic location 120 or may be accessible via one or more external systems.

User preference manager 121 may include multiple groupings of user preferences 140, including but not limited to, those related to the attributes, qualities, management, and display of imagery. User preferences 140 may be defined globally, for all images or for subsets of images, such as for images of a certain type.

An individual user may define information and criteria necessary to initialize and utilize a user preference, or preferences may be automatically detected. User preferences 140 related to the attributes and qualities of imagery may also be configured for the purpose of ranking and filtering imagery 160.

User preferences 140 associated with user preference manager 121 may be presented to a user for configuration in a variety of ways. According to an embodiment, a user may configure user preferences 140 manually from a user preference management view. According to another embodiment, one or more modifiable user preferences may presented to a user on an interface that also displays maps, panoramas, or geolocated imagery.

System 120 also includes user interface generator 122 to provide at least one geographic map or panoramic imagery to a client for display in an interface configured for interactive navigation of the at least one geographic map or panoramic imagery. User interface generator 122 may retrieve and even generate geolocated content for a client to use for display.

A user may invoke user interface generator 122 from a client in any number of ways including by entering a street address or geographic coordinates, selecting a predefined geographic location, entering a point of interest by name, clicking on a location on a displayed map, or drawing a rectangle or other shape on a displayed map to indicate a selected geographic area.

According to an embodiment, user interface generator 122 generates an online map for a user-specified location to be displayed within an application or a web browser on a client device. The generated map includes at least one representation indicating the existence of one or more types of imagery for displayed locations.

The existence of available imagery may be shown using markers such as dots or graphical icons. In another embodiment, areas of a map having available imagery are outlined in a particular color. Different markers and overlay colors may be used to indicate various types of available imagery. These indicators also may be customizable based on user preferences 140.

System 120 includes user selection processor 123, configured to receive a user selection collected by the user interface indicating a geographic location corresponding to displayed geolocated imagery. According to an embodiment, a user may indicate a desire to view imagery associated with a geographic location by selecting, dragging, and dropping an icon onto an area of a map, such as a marker or colored overlay, which indicates the existence of available imagery.

System 120 includes image identifier 124 to identify a plurality of imagery 160 associated with a user selection. Multiple images and image types may be associated with a geographic location or other imagery based on location.

Image identifier 124 is responsible for finding imagery 160 near a particular location or geolocated image that has been selected by a user. The range distance used when detecting nearby imagery may be a default system setting or may be configured based on one or more user preferences 140, based on a distance, radius or coverage area. According to an embodiment, image identifier 124 may identify related imagery using geographical coordinates associated with geotagged imagery.

In another embodiment, image identifier analyzes imagery 160 from one or more available sources. Imagery 160 may be stored on a local or remote computer system. In addition, imagery 160 may be preprocessed or analyzed in real-time. Image properties may be stored within the image file itself along with the image. Image properties also may be stored externally. External storage locations may include a separate file or within a database management system.

In another embodiment, image identifier 124 also may be configured to identify related imagery based on one or more image properties, either in combination with or independent of geographic location. Image identifier 124 also may be configured to ignore one or more image types. Image identifier 124 also may be configured to filter out individual images having one or more properties indicated as undesirable, based on one or more user preferences 140.

System 120 includes image rank determiner 125 to rank identified imagery 160 based on one or more user preferences 140. Image rank determiner 125 operates to evaluate identified imagery in relation to user preferences 140 and may rank images in various ways.

According to one embodiment, image rank determiner 125 may rank images based on the count of matches between user preferences and image properties. In another embodiment, image rank determiner 125 may also calculate a score for each identified image based on a weighting assigned to one or more user preferences 140. In an alternative embodiment, each matching user preference may be assigned a numerical value, which then may be aggregated or incorporated into a formula to produce a calculated score. Identified images may then be ranked according to the calculated score. In addition to user preferences 140, other factors may be considered when determining the rankings.

System 120 also includes image provider 126 to provide at least one ranked image for display based on the ranking performed by image rank determiner 125. The ranked images may be presented to a user in any number of display formats.

According to an embodiment, the highest ranked image is presented in a main display panel. Additional ranked images are presented as thumbnail images in a preview panel. A user may browse the images contained in the preview panel and scroll to preview other ranked images that may not be displayed. A user may select a preview image by clicking the image. When a preview image has been selected, it is then presented in the main display panel.

FIG. 1B is a block diagram of system 102, which illustrates client and server components of a system for providing imagery associated with a geographic location to a user, according to an embodiment. System 102, and its components, may be part of, or may be implemented with, one or more computing devices, as described above with respect to FIG. 1A.

System 102 includes a client 104 and server 108, which communicate over a network, such as the internet 106. Client 104 may be implemented using a variety of computing devices, which include but are not limited to a computer, workstation, distributed computing system, computer cluster, cloud computer system, embedded system, stand-alone electronic device, networked device, mobile device (e.g. mobile phone, smart phone, navigation device, tablet or mobile computing device).

Client 104 includes user interface requestor 110, user interface receiver 112, user interface displayer 114, user preference and selection collector 116, and user preference and selection sender 118.

System 102 also includes a system for providing imagery associated with a geographic location 120, which resides on server 108. Server 108 may include one or more logical or physical computer systems, which each may contain one or more components of a system for providing imagery associated with a geographic location 120.

User interface requestor 110 may be used by client 104 to create and send user interface requests to a system for providing imagery associated with a geographic location 120 residing on server 108. According to an embodiment, client 104 utilizes user interface requestor 110 to create and send a request to user interface generator 122, for information and/or content needed to display at least one geographic map or panoramic imagery to a client in an interface configured for interactive navigation of the at least one geographic map or panoramic imagery.

User interface receiver 112 may be used by client 104 to receive user interface related messages and responses sent from user interface generator 122. According to another embodiment, user interface generator 122 provides map information, panoramic imagery, and other information for use in displaying an interface on a device where client 104 executes, in response to a request from user interface requestor 110 of client 104. User interface generator 122 sends the generated interface to client 104, which is received by user interface receiver 112.

User interface displayer 114 may be used by client 104 to display any user interface, information, and imagery on a device where client 104 executes. In another embodiment, user interface displayer 114 may modify a user interface to optimize display on a client device and may also display content based on one or more user preferences 140. According to additional embodiments, user interface displayer 114 may display an interface within a web browser or as part of a standalone application running on client 104.

User preference and selection collector 116 may be used by client 104 to collect user preferences indicated by a user and also to collect user selections pertaining to geographic locations, geographic maps, and panoramic imagery. In an embodiment, user preference and selection collector collects a user selection made by a user using an interface displayed on client 104. The user selection is then passed along to user preference and selection sender 118, which sends the collected user selection to user selection processor 123 for processing by system for providing imagery associated with a geographic location 120.

User preference and selection sender 118 may send user preferences and selections received from user preference and selection collector 116 and send the collected preferences and selections to user selection processor 123 for processing.

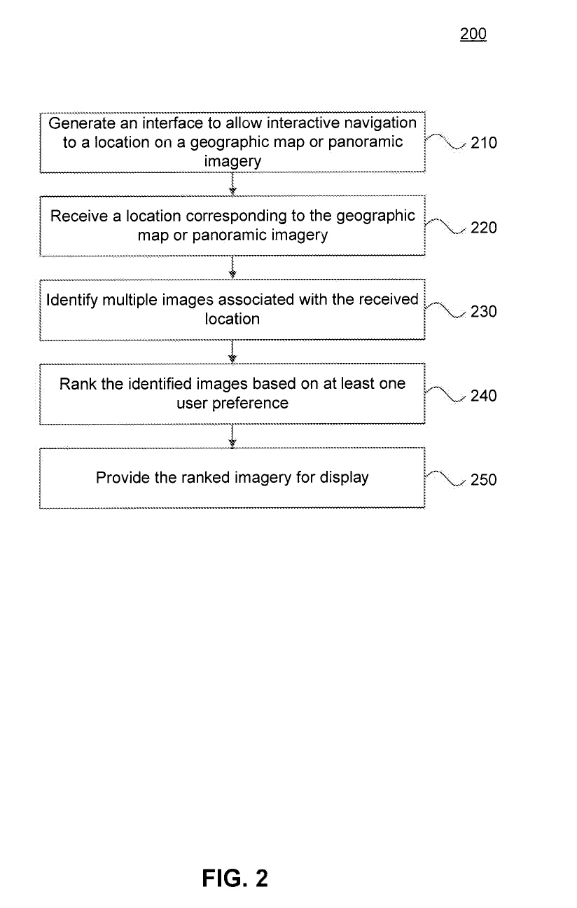

FIG. 2 is a flow diagram of a method for presenting imagery associated with a geographic location to a user, according to an embodiment. Method 200 begins at step 210 where a user interface to allow interactive navigate to a location on a geographic map or panoramic imagery is generated. In another embodiment, the provided interface also may be further configured to permit the selection of imagery captured from one or more orientations, directions, or perspectives. In an additional embodiment, the interface may be configured to allow selection of a default imagery type to display when multiple types, such as photographs and panoramic imagery, exist for a location.

Step 210 may be performed by user interface generator 122, which may provide maps, imagery, and other information to client 104 based on a request from user interface requestor 110. User interface generator 122 may send maps, imagery, and other information to user interface receiver 112, which may be used by user interface displayer 114 to create, modify, and present a user interface to a user on client 104.

At step 220, a user selection indicating a location corresponding to the geographic map or panoramic imagery is received by user selection processor. Users may indicate a location by entering a street address or geographic coordinates, selecting a predefined geographic location, entering a point of interest by name, clicking on a location on a displayed map, or drawing a rectangle or other shape on a displayed map to indicate a geographic area. According to an embodiment, the user may click, drag and drop an icon onto geolocated imagery to specify a location. The selection may be collected by user preference and selection collector 116, passed to user preference and selection sender 118, and received by user selection processor 123 for processing.

At step 230, multiple images associated with the selected location are identified. Imagery 160 may be stored locally or remotely on one or more computer systems or computer-accessible storage devices. Imagery 160 may also be accessed from sources controlled by a map service provider itself, affiliates, or unassociated third-party sources, either directly or through an application programming interface. Imagery 160 may be processed dynamically, preprocessed, indexed, and cached, as needed, for performance and other implementation-related purposes. Step 230 may be performed by image identifier 124.

At Step 240, the identified images may be ranked based on one or more user preferences 140. According to an embodiment, a user preference may include images having at least a certain number of impressions. Impressions refer to how many times an image has been displayed or has been selected for display by a system or combination of systems. Another user preference may include image density, which refers to the number of images available in a certain geographic location or area. Image density will usually be high in places of interest where tourists and visitors take a large number of photographs. According to another embodiment, information relating to images, such as image density, impressions, ratings, comments, and other information that is stored on external systems, such as a photo sharing website or a social networking website, may obtained from one or more external systems or websites either directly or through an API.

User preferences also may include content or conditions present within or captured by an image, such as colors, textures, shapes, objects, and settings. For example, a user may wish to locate images having certain colors, images taken during the day or at night, images taken on a sunny day, images of a particular statue or building, or related images based upon similar detected contents.

According to another embodiment, a user may set one or more preferences for viewing images based on third-party feedback such as ratings, comments, “likes”, or votes. The user may indicate specific third-patty feedback criteria and also may define one or more thresholds for filtering and ranking imagery based on comments and ratings of others.

According to an additional embodiment, a user may specify one or more preferences related to imagery navigation options. Related images from different sources may be linked together to allow navigation from one image to another, much like browsing a well-formed panorama. Imagery navigation options refer to the ability to navigate between images having a direct, overlapping, homographic, or some other relationship. Such navigation may be directional or may be based on one or more zoom levels for imagery at a location.

In an embodiment, a user may wish to set a preference for imagery having at least a certain number of navigation options to other nearby imagery. Further, preferences for imagery having one or more specific directional navigation options to related imagery may be indicated by the user. These directional navigation options may include one or more specific directions, zoom levels, cardinal directions, or ordinal directions. In addition, image ranking also may be based on an orientation, direction or perspective of an image. Step 240 may be performed by image rank determiner 125.

At step 250, ranked imagery and associated ranking information is provided for display. According to an embodiment, image provider 126 sends the ranked imagery and associated ranking information to user interface receiver 112 for display by user interface displayer 114 on a device executing client 104. According to another embodiment, user interface displayer 114 may display ranked imagery sequentially based on ranking. In another embodiment, the ranked imagery may also be presented in one or more groups or collections of ranked imagery by user interface displayer 114.

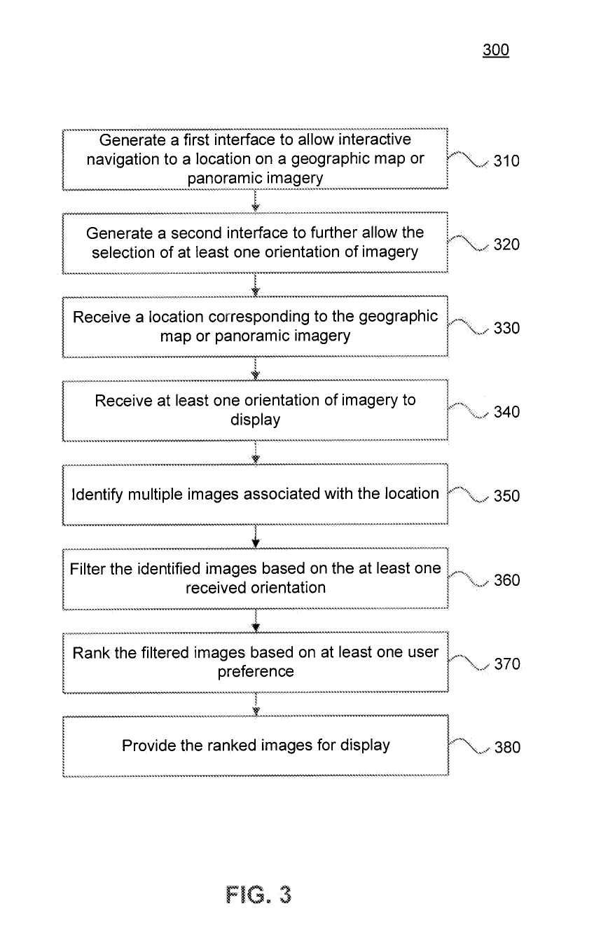

FIG. 3 is a flow diagram of another method 300 for presenting imagery associated with a geographic location to a user, according to an embodiment. Method 300 combines filtering and ranking of images based on user preference. In addition, method 300 may also include a second user interface to allow a user to interactively select preferred image orientations, directions, and/or perspectives.

At step 310, a first user interface to allow a user to interactively navigate to a location on a geographic map or panoramic imagery is generated. Step 310 may be performed by user interface generator 122 in response to a request from user interface requestor 110. User interface generator 122 may send the generated interface to user interface receiver 112 to be displayed by user interface displayer 114 on a client 104.

At step 320, a second user interface configured to allow a user to select one or more orientations, directions, or perspectives of imagery is provided. For example, a user may indicate a preference for viewing panoramic imagery with an orientation facing the south for a particular location. According to an embodiment, the second user interface may be physically contained within the first user interface, for example, within a frame. In another embodiment, the second user interface may be displayed in a separate window. Step 320 may be performed by user interface generator 122, which may send the generated interface to user interface receiver 112 to be displayed by user interface displayer 114 on client 104.

At step 330, a first user selection indicating a location corresponding to the geographic map or panoramic imagery is received from the first user interface. According to an embodiment, a user may initially specify a geographic location and may later narrow the scope of returned results by indicating a preference for imagery having one or more orientations, directions, or perspectives, using the second interface. In another embodiment, a user may initially indicate desired orientations, directions, or perspectives using the second interface, which can be considered once a location has been selected. Step 330 may be performed by user selection processor 123, which may receive a user selection collected by user preference and selection collector 116 that is sent by user preference and selection sender 118.

At step 340, a second selection indicating one or more orientations of imagery to display is received from the second user interface. The orientation, direction and perspective of imagery may include the position and viewpoint or a navigational direction from where the imagery was taken or is viewed. For example, a user may indicate a preference to view imagery facing both the north and east, which gives the user more control over the imagery that is displayed. Step 340 may be performed by user selection processor 123, which may receive a user selection that is collected by user preference and selection collector 116 and sent by user preference and selection sender 118.

At step 350, multiple images associated with the selected location are identified. When a user indicates or selects a location on a zoomed-out map for a broad geographic region, the multiple images identified for the geographic region may include landmarks and points of interest associated with the region. According to an embodiment, such landmarks and points of interest may be identified based on image properties, which may include a number of impressions for an image and/or the density of available images for a location. Step 350 may be performed by image identifier 124.

At step 360, the identified images are filtered based on received user-selected orientations. In an embodiment, a user may indicate a preference to only display imagery from one or more orientations. In another embodiment, imagery also may be filtered according to a second individual or second set of user preferences. For example, a user may filter image results by date, based on a desire to view results contained within a particular date range. In addition, a user may want to view nighttime images taken for a given location and may also filter results based on a date or time when photos were taken. Other embodiments may include the option to filter imagery based on one or more user preferences 140 indicating or associated with the identification of contents detected within the imagery.

Imagery filtering step 360 may either precede or follow imagery ranking step 370. It is also possible for both steps to be performed together in a single action. For example, filtering and ranking criteria may be executed as part of a single database query. Step 360 also may be performed by image identifier 124.

At step 370, the identified and filtered images are ranked based on one or more user preferences 140. In an embodiment, a user may indicate a preference for imagery based on density of nearby imagery. In another embodiment, a user may specify a preference for displaying particular types of imagery by default when multiple image types, such as photographs and panoramic imagery are both available. In an additional embodiment, a user may indicate a preference for images from one or more orientations, directions, or perspectives.

Images may be ranked using one or more methods. According to an embodiment, image ranking may be based on the overall number of matches between image properties and user preferences. In another embodiment, user preferences may be weighted according to importance and a ranking score may be calculated for each image prior to ranking. Step 370 may be performed by image rank determiner 125.

At step 380, the ranked imagery and associated ranking information is provided for display. In an embodiment, thumbnail previews of selectable ranked images may be provided for display on client 104 by user interface displayer 114. In another embodiment, one or more full-size or reduced-size ranked images may be superimposed on a map, panoramic image, or other geolocated imagery and displayed on client 104 by user interface displayer 114. In an additional embodiment, the user may specify one or more customizable preferences associated with a display layout, which may be used by user interface displayer 114 to display the ranked images. Step 380 may be performed by image provider 126, which may provide ranked images and associated ranking information to user interface receiver 112 on client 104 for display by user interface displayer 114.

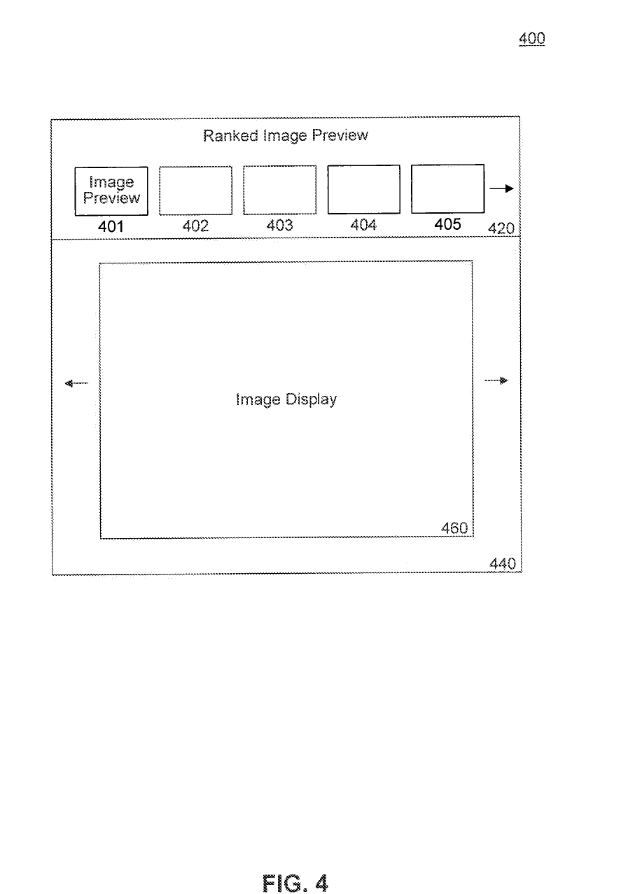

FIG. 4 is an illustration of a user interface for displaying a discrete set of photos and panoramas for a geographic location to a user, according to an embodiment. According to an embodiment, such an illustration may be displayed by user interface displayer 114 on a device executing client 104. User display 400 may include ranked image preview 420 and image display 460. Ranked image preview 420 allows a user to view and navigate a manageable subset of filtered and ranked imagery associated with a geographic location in a reduced-size or thumbnail format.

Image previews 401, 402, 403, 404 and 405 may be fixed or scrollable and also may include additional image previews not initially visible to the user. Image previews 401-405 may be displayed in order of ranking based on user preferences. A user may display a larger or full-size version of an image in image display 460 by selecting any single image presented within ranked image preview 420. Further, the user also may display other images within image display 460 by using navigation controls, such as those illustrated in display section 440.

While display section 440 may be dedicated to displaying imagery associated with a geographic location, it also may include corresponding map or panoramic imagery, additional navigation controls, and user preference selection options. In addition, ranked images may be superimposed on one or more geographic maps or panoramic images.

The display layout presented in user display 400 is only one example of an embodiment. Different display layouts may be presented based on one or more user preferences 140 associated with a display layout, device capabilities, display limitations, and/or available bandwidth.

### Example Computer Embodiment

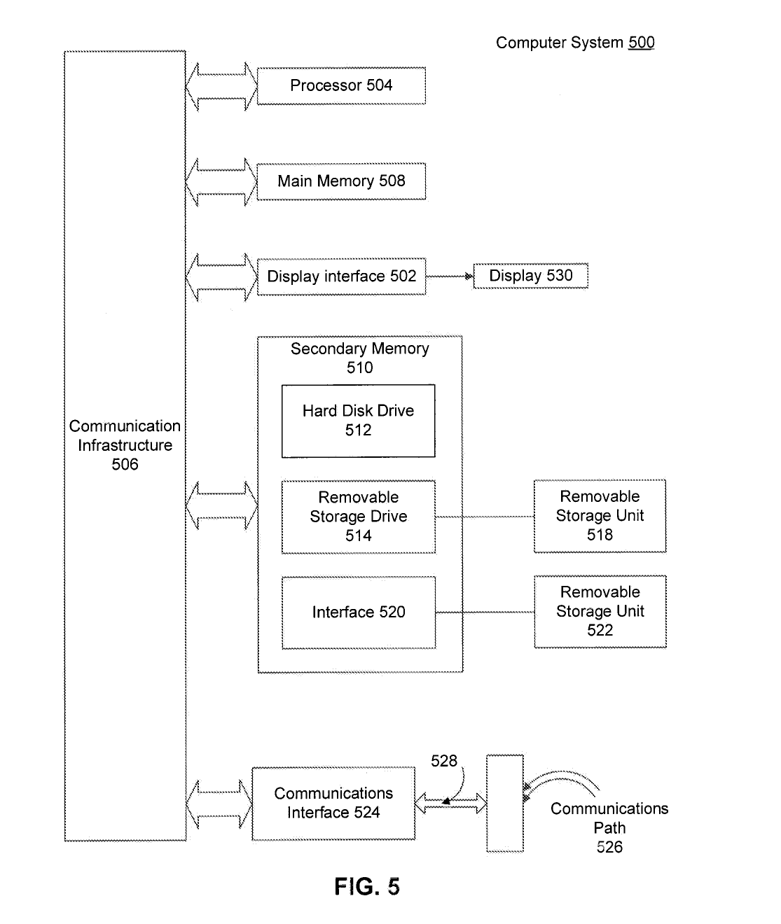

In an embodiment, the systems and components of embodiments described herein are implemented using well-known computers, such as example computer system 500 shown in FIG. 5.

Computer system 500 can be any commercially available and well-known computer capable of performing the functions described herein, such as computers available from Lenovo, Apple, Oracle, HP, Dell, Cray, etc.

Computer system 500 includes one or more processors (also called central processing units, or CPUs), such as a processor 504. Processor 504 is connected to a communication infrastructure 506.

Computer system 500 also includes a main or primary memory 508, such as random access memory (RAM). Main memory 508 has stored control logic (computer software), and data.

Computer system 500 also includes one or more secondary storage devices 510. Secondary storage device 510 includes, for example, a hard disk drive 512 and/or a removable storage device or drive 514, as well as other types of storage devices, such as memory cards and memory sticks. Removable storage drive 514 represents a floppy disk drive, a magnetic tape drive, a compact disk drive, an optical storage device, tape backup, etc.

Removable storage drive 514 interacts with a removable storage unit 518. Removable storage unit 518 includes a computer usable or readable storage device having stored thereon computer software (control logic) and/or data. Removable storage unit 518 represents a floppy disk, magnetic tape, compact disk, DVD, optical storage disk, or any other computer data storage device. Removable storage drive 514 reads from and/or writes to removable storage unit 518 in a well-known manner.

Computer system 500 also includes input/output/display devices 530, such as monitors, keyboards, pointing devices, etc., which communicate with communication infrastructure 506 through a display interface 502.

Computer system 500 further includes a communication or network interface 524. Communications interface 524 enables computer system 500 to communicate with remote devices. For example, communications interface 524 allows computer system 500 to communicate over communications path 526 (representing a form of a computer usable or readable medium), such as LANs, WANs, the Internet, etc. Communications interface 524 may interface with remote sites or networks via wired or wireless connections.

Control logic may be transmitted to and from computer system 500 via communication path 526. More particularly, computer system 500 may receive and transmit carrier waves (electromagnetic signals) modulated with control logic via communication path 526.

Any apparatus or article of manufacture comprising a computer usable or readable medium having control logic (software) stored thereon is referred to herein as a computer program product or program storage device. This includes, but is not limited to, computer system 500, main memory 508, secondary storage device 510, and removable storage unit 518. Such computer program products, having control logic stored thereon that, when executed by one or more data processing devices, causes such data processing devices to operate as described herein, represent embodiments of the invention.

Embodiments can work with software, hardware, and/or operating system implementations other than those described herein. Any software, hardware, and operating system implementations suitable for performing the functions described herein can be used. Embodiments are applicable to both a client and to a server or a combination of both.

Embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed. The breadth and scope of the present invention should not be limited by any of the above-described exemplary embodiments.

In addition, the foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

1. A computer-implemented method for presenting imagery associated with a geographic location to a user comprising:
providing, using one or more computing devices, at least one geographic map or panoramic imagery to a client device for display in an interface configured for interactive navigation of the at least one geographic map or panoramic imagery;
receiving, using the one or more computing devices, a user selection, collected via the interface, indicating a particular location corresponding to the at least one geographic map or panoramic imagery, wherein the particular location is associated with a plurality of images;
in response to receiving the user selection, identifying, using the one or more computing devices, the plurality of images using the particular location of the user selection;
obtaining, using the one or more computing devices, at least one user preference including a navigation option for navigating to other imagery;
ranking, using the one or more computing devices, the identified images, each identified image receiving a score based on the at least one user preference; and
providing, using the one or more computing devices, at least one ranked image for display in the interface in accordance with the ranking.

2. The method of claim 1, further comprising:
filtering the identified images based on a second user preference associated with the identified images.

3. The method of claim 1, wherein the ranking is at least partially based on a user preference related to a number of impressions associated with an image.

4. (canceled)

5. The method of claim 1, wherein the navigation option includes a certain number of navigation options to other images.

6. The method of claim 5, wherein the navigation option is a directional navigation option for navigating between images in a particular direction.

7. The method of claim 1, wherein the ranking is at least partially based on a user preference related to image orientation.

8. The method of claim 1, wherein the ranking is at least partially based on a user preference related to density of available imagery near an image.

9. The method of claim 1, wherein the at least one ranked image displayed for a geographic region is a landmark or point of interest.

10. The method of claim 2, wherein the filtering is at least partially based on a user preference pertaining to contents detected within the identified imagery.

11. The method of claim 1, wherein the at least one ranked image is displayed by superimposing it on the at least one geographic map or panoramic image.

12. The method of claim 1, wherein the at least one ranked image is displayed as a thumbnail image.

13. The method of claim 1, wherein the at least one ranked image is displayed based on a user preference associated with a display layout.

14. The method of claim 1, wherein the interface is further configured to select imagery from one or more orientations.

15. (canceled)

16. (canceled)

17. The method of claim 1 further comprising:
displaying a second interface configured to allow the user to select at least one orientation of imagery;
receiving a user selection indicating the at least one orientation of imagery; and
filtering the identified imagery based on the received selection.

18. A computer-readable storage medium having control logic recorded thereon that if executed by a processor, causes the processor to perform operations to present imagery associated with a geographic location to a user, the operations comprising:
a first computer-readable program code to cause the processor to display an interface to interactively navigate to at least one geographic map or panoramic imagery;
a second computer-readable program code to cause the processor to receive, via the interface, a user selection indicating a particular location corresponding to the at least one geographic map or panoramic imagery, wherein the particular location is associated with a plurality of images; and
a third computer-readable program code to cause the processor to:
in response to the processor receiving the user selection, identify the plurality of images using the particular location of the user selection;
obtain at least one user preference including a navigation option for navigating to other imagery;
rank the identified images, each identified image receiving a score based on the at least one user preference; and
display at least one ranked image based on the ranking.

19. A system for presenting imagery associated with a geographic location to a user, comprising:
a processor;
a user interface generator configured to display, using the processor, an interface to interactively navigate to at least one geographic map or panoramic imagery;
a user selection processor configured to receive, using the processor and via the interface, a user selection indicating a particular location corresponding to the at least one geographic map or panoramic imagery, wherein the particular location is associated with a plurality of images;
an image identifier configured to identify in response to the receiving the user selection, using the processor, the plurality of images using the particular location of the user selection;
a user preference manager configured to store and retrieve, using the processor, at least one user preference;
an image rank determiner configured to rank, using the processor, the identified images, each identified image receiving a score based on the at least one user preference including a navigation option for navigating to other imagery; and
an image presenter configured to display, using the processor, at least one ranked image based on the ranking.

20. The computer-readable storage medium of claim 18, further comprising:
a fourth computer-readable program code to cause the processor to filter the identified images based on a second user preference associated with the identified images.

21. The computer-readable storage medium of claim 18, further comprising:
a fourth computer-readable program code to cause the processor to:
display a second interface configured to allow the user to select at least one orientation of image;
filter the identified image based on the received selection.

22. The system of claim 19 further comprising:
an image filter configured to filter, using the processor, the identified images based on a second user preference associated with the identified images.

23. The system of claim 19, wherein the image presenter is further configured to display a second interface configured to allow the user to select at least one orientation of image; the user selection processor is further configured to receive a user selection indicating the at least one orientation of image; and the image identified is further configured to filter the identified image based on the received selection.
